(19) United States
(12) Patent Application Publication
(10) Pub. No.: US 2020/0364646 A1
(43) Pub. Date: Nov. 19, 2020

(54) Automated Assignment of Tasks Based on User Profile Data for Improved Efficiency

(71) Applicant: INTERNATIONAL BUSINESS MACHINES CORPORATION, Armonk, NY (US)

(72) Inventors: Raphael Arar, Santa Cruz, CA (US); Guangjie Ren, Belmont, CA (US); Lei Huang, Mountain View, CA (US); Shun Jiang, San Jose, CA (US); Eric Liu, San Jose, CA (US)

(21) Appl. No.: 16/412,393

(22) Filed: May 14, 2019

(51) Int. Cl. G06Q 10/06; G06F 17/27

(52) U.S. Cl. CPC G06Q 10/063112; G06F 17/2785; G06Q 10/06315

(57) ABSTRACT

A method and system of matching a participant to a task are provided. A project is received and its parameters determined. Tasks of the project are determined from the parameters. For each task, parameters of the task are determined, comprising a time to perform the task and a threshold level of expertise to perform the task. Profile information of potential participants is received that is filtered based on the time to perform the task, to conserve a memory and a processing power of the computer device. The task is assigned to a participant of the filtered potential participants based on multi-variable optimization on cost, time, and quality of a deliverable of the task.

### BACKGROUND

### Technical Field

The present disclosure generally relates to computer systems, and in particular, to a computerized determination of task allocation in complex systems.

### Description of the Related Art

Today, projects at organizations are becoming increasingly complex, involving various interdependent tasks, each having individual skill level considerations. These tasks are often assigned to relatively open and rapidly-evolving group of individuals. Each individual, sometimes referred to herein as a participant, brings with them a set of knowledge bases, skill sets, experiences, and understanding that is unique to them. Similarly, many tasks, be they human interactions or human-machine interactions, involve a specific set of human knowledge bases, skill sets, experiences, and understanding that may be unique to a small set of individuals, and only partially possessed by a larger set of individuals. Matching the specific individual to the specific task in such a way that the individual and global degrees of mis-match in an organization are minimized becomes increasingly challenging when the tasks become more complex and are crowdsourced to a large group of participants.

### SUMMARY

According to various embodiments, a computing device, a non-transitory computer readable storage medium, and a method are provided for matching a participant to a task. A project is received and its parameters determined. Tasks of the project are determined from the parameters. For each task, parameters of the task are determined, comprising a time to perform the task and a threshold level of expertise to perform the task. Profile information of potential participants is received that is filtered based on the time to perform the task, to conserve a memory and a processing power of the computer device. The task is assigned to a participant of the filtered potential participants based on multi-variable optimization on cost, time, and quality of a deliverable of the task.

In one embodiment, the parameters of the project include a total cost, quality, time to complete the project and the tasks involved. The parameters may further include any interdependencies between the tasks or an enterprise policy for the project. The enterprise policy may be extracted from one or more documents having natural language content, through natural language processing (NLP).

In one embodiment, the time to perform the task comprises a start time range and an expected duration of the task.

In one embodiment, determining the parameters of the task further includes determining whether the task can be performed in parallel.

In one embodiment, for each task, upon determining that the task is behind schedule and that a subsequent task can be performed in parallel, the subsequent task is reassigned to one or more additional participants such that the corresponding project completes on schedule.

According to one embodiment, a computing device is provided that is specifically configured to match a participant to a task in an environment of multiple projects. A plurality of projects is received. Parameters of each of the plurality of projects are determined. For each project, the tasks of the project are identified from its parameters. For each task, parameters of the task are determined, comprising a time to perform the task and a threshold level of expertise to perform the task. Profile information of potential participants is received that is filtered based on the time to perform the task, to conserve the storage device and a processing power of the processor. The task is assigned to a participant of the filtered potential participants based on multi-variable optimization on cost, time, and quality of a deliverable of the task.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 illustrates an example architecture of a participant matching system in an environment of multiple projects.

FIG. 2A illustrates an example table for a project.

FIG. 2B illustrates an example participation profile table.

FIG. 3 is a conceptual block diagram of a participant matching system, consistent with an illustrative embodiment.

FIG. 4 presents an illustrative process related to matching a task in a multi task and multi project environment to an appropriate participant.

FIG. 5 provides a functional block diagram illustration of a computer hardware platform that can be used to implement a particularly configured computing device that can host a matching engine.

FIG. 6 depicts a cloud computing environment, consistent with an illustrative embodiment.

FIG. 7 depicts abstraction model layers, consistent with an illustrative embodiment.

### DETAILED DESCRIPTION

### Overview

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

The present disclosure generally relates to systems and computerized methods of automatically assigning tasks of one or more complex projects to a pool of participants, sometimes referred to herein as crowdsourcing. In recent years, there has been a trend toward workplace flexibility. Telecommuting, flexible schedules, and availability of a pool of participants via crowdsourcing reflect the changes in the human labor sourcing models, where services can be divided between participants to achieve a cumulative result. At the same time, projects at organizations, such as business enterprises, have grown increasingly complex, having tasks that may be interdependent, involving a diverse skill set and different levels of expertise for those skill sets, and facing ever shorter deadlines for completion. Accordingly, these organizations find it increasingly difficult to assign tasks to qualified participants to attain a desired result at an optimal time, cost, and quality. For example, controlling the quality of the results is a challenging issue, due to the unreliability, volatility or lack of skills of participants. In particular, in a multi-project environment, where each project has complex interdependencies and where different specific expertise is involved to complete each corresponding task of a project, it is impractical, if not impossible, to identify an appropriate participant for each task such that each project is optimized for its relevant goal. For example, project 1 of an organization may be cost sensitive and have a strict delivery deadline. Project 2 of the organization may involve a threshold level of quality and be strategically important to the organization. Project 3 of the organization may have a strict delivery deadline and a threshold level of quality. At the same time there may be a changing pool of workers, having different availability, and an evolving skill set. Simply assigning a task to the most qualified participant may not provide a result that is consistent with an enterprise policy of the organization, ultimately resulting in wasted human resources, quality of the result, and total cost of a project.

Accordingly, what is provided herein are a computationally efficient methods and systems of assigning tasks to qualified participants in such a way where the enterprise policy regarding the corresponding project is maintained. Reference now is made in detail to the examples illustrated in the accompanying drawings and discussed below.

### Example Architecture

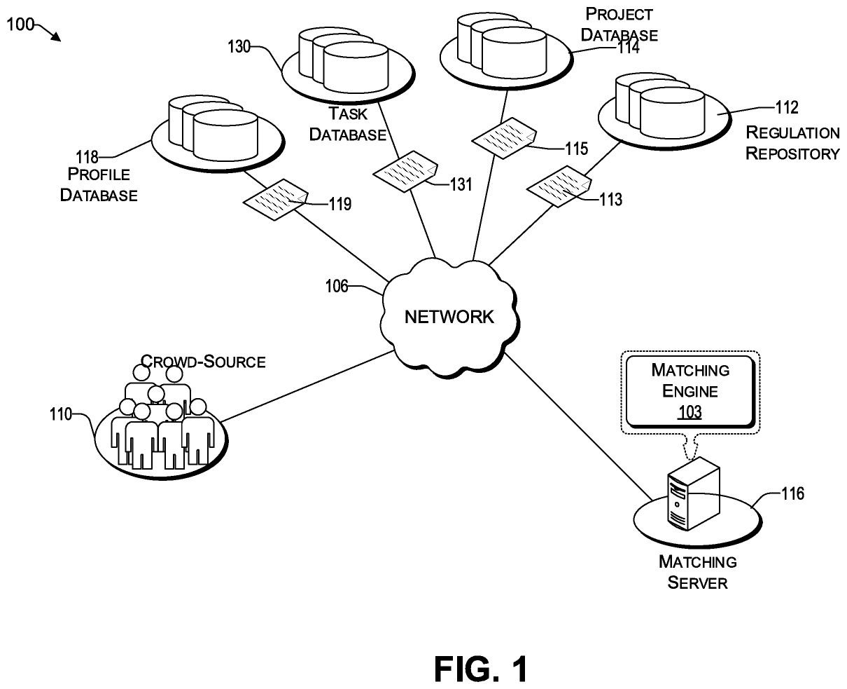

FIG. 1 illustrates an example architecture 100 of a participant matching system in an environment of multiple projects. Architecture100 may include a profile database 118, a task database 130, a project database 114, and a regulation repository 112. The architecture 100 further includes potential participants 110, sometimes referred to herein as crowd-source.

The architecture 100 includes a matching server 116 that hosts a matching engine 103. There is a network that 106 allows the matching engine 103 to communicate with various resources connected to the network 106, such as the regulation repository 112, project database 114, profile database 118, and task database 130, and the list of potential participants 110. The network 106 may be, without limitation, a local area network (“LAN”), a virtual private network (“VPN”), a cellular network, the Internet, or a combination thereof. For example, the network 106 may include a mobile network that is communicatively coupled to a private network, sometimes referred to as an intranet, that provides various ancillary services, such as communication with various databases, potential participants, the Internet, and the cloud.

The regulation repository 112 is configured to store and maintain an up-to-date list of regulations or industry standards, referred to herein as compliance control documents, for various types of projects. Industry standards include a compliance domain that is external to a company (e.g., client domain), which is useful for certification of a client domain's product, or capabilities, and are adhered to in order to improve interoperability of applications and systems, as well as attest to a specified level of quality. In addition, there may be internal parameters of a client domain, which may include the infrastructure (physical properties, hardware, and software of the client domain) as well as internal regulations. For example, the internal regulations may be additional quality control measures that are implemented by the client domain to not only achieve compliance with regulations but to achieve a higher quality product or service.

In one embodiment, the regulation repository 112 includes the parameters for various projects of an organization. For example, the parameters of a project may include, without limitation, the category of the project, reflecting the enterprise policy for that project, cost, quality level, time constraints, required clearance, and level of importance to the organization. In other embodiments, the parameters of the project are extracted by the matching engine 103, discussed in more detail below.

In some embodiments, the parameters of the project are included in one or more documents that may be disparate in form (e.g., different document type, such as PowerPoint, Word document, spreadsheet, PDF document, picture, etc.,) collectively referred to herein as natural language content. The matching engine 103 may use natural language processing (NLP) to process the raw natural language content of the one or more compliance control documents 113 to extract therefrom the parameters of the project. For example, the natural language content may be provided as a text. In one embodiment, concept expansion, such as the IBM Watson® concept expansion, can be used to identify the concept cues in the compliance control documents 113 to determine the intent thereof. In this regard, large sets of unstructured sets of data may be provided to the matching engine 103 during a training phase, such that it can learn therefrom. The large sets of unstructured data may relate to prior compliance control documents 113 that were successfully processed by the matching engine 103, which now acts as a corpus of data to learn from. Such concept expansion enables the creation of a specialized dictionary for the cognitive application of identifying the parameters of the project from the compliance control document 113. Concept expansion enables the matching engine 103 to build a specialized dictionary for the cognitive application of interacting with documents that include raw natural language. Accordingly, the matching engine 103 can correctly understand industry specific terminology, local euphemisms, and colloquial terms that may be included as input data in the compliance control documents 113.

The regulation repository 112 may be maintained by the organization or a consortium of organizations and/or individuals interested in maintaining various regulations for one or more industries. In one embodiment, the matching engine 103 can, at predetermined intervals or at a trigger event, receive the compliance control documents 113 to extract therefrom the parameters of the project to better match the tasks inherent therein to appropriate participants.

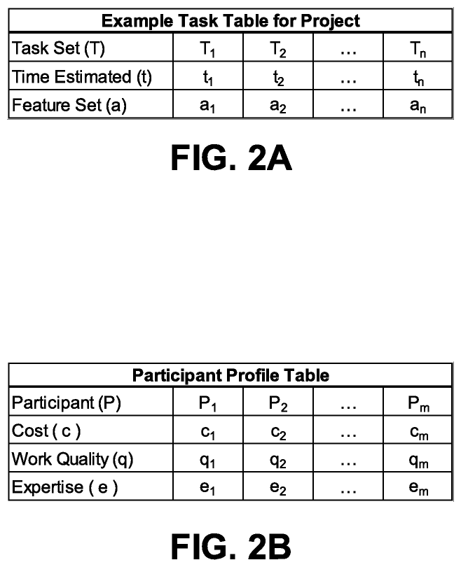

The project database 114 represents one or more databases that keep track of the various projects of an organization that may be managed by the matching engine 103. Stated differently, the project database 114 is a source of requests for tasks that are to be completed via the crowd-source 110, facilitated by the appropriate matching via the matching engine 103. To that end, the matching engine 103 actively monitors the project database 114 at predetermined intervals or upon a trigger event (e.g., a new project becoming available in the project database 114). FIG. 2A illustrates an example table for a project. The table includes the task set (T), a time estimate (t) and a feature set (a) for each task.

Referring back to FIG. 1, the task database 130 is a repository of the various tasks that are associated with corresponding projects, both active and completed. For example, the matching engine 103 can use the corpus of data of the tasks associated with projects that were previously successfully completed as a reference for the time (e.g., number of hours) a task is expected to take to successfully complete and other parameters of the task, such as the threshold level of expertise involved (e.g., number of years' experience, education level, accreditations, capabilities, etc.). Based on the machine learning, patterns, trends, and key words that are consistent with features are identified. In various embodiments, the machine learning discussed herein may be supervised or unsupervised. In supervised learning, the matching engine 103 may be presented with example data 131 from the task database 130 as being acceptable, based on the successfully completed projects. Stated differently, the task database 130 acts as a teacher for the matching engine 103. In unsupervised learning, the task database 130 does not provide any labels as what is acceptable, rather, it simply provides historic data of completed tasks to the matching engine 103 that can be used together with the tasks associated with a new project to find its own structure among the data to extract therefrom the relevant parameters of the task.

In various embodiments, the machine learning may make use of techniques such as supervised learning, unsupervised learning, semi-supervised learning, naïve Bayes, Bayesian networks, decision trees, neural networks, fuzzy logic models, and/or probabilistic classification models.

The profile database 118 represents a repository that includes a profile of each of the list of potential participants 110. For example, the profile 119 may include, without limitation, education level, list of skills, length of experience for different skills, peer rating, publications, as well as availability of a participant. In this regard, FIG. 2B illustrates an example participation profile table. By way of example only and not by way of limitation, FIG. 2B characterizes a participant in terms of cost, work quality and expertise for a corresponding skill. Thus, the cost, work quality and expertise may be different for the same participant for different skills.

It will be understood that the sheer volume of list of potential participants and the profile associated therewith may provide a technical challenge for not only the network 106, but also the computing resources of the matching server 116 hosting the matching engine 103, including processing time and memory resources of the matching server 116. In this regard, the matching engine 103 is configured to invoke a pre-filtration of the profile database 118 such that the participant profiles 119 of potential participants that are available for predetermined time periods are received over the network 106 to the matching server 116 to be processed by the matching engine 103. For example, the matching engine 103 sends the relevant time periods via the network 106 to the profile database 118, such that the pre-filtration is performed before the participant profiles 119 are sent to the matching engine 103. In this way, a technical effect of conserving valuable network resources 106, as well as computing and storage resources of the matching server 116 are achieved. By virtue of limiting the computation to a reduced pool of permutations, the computational demand on the matching server 116 is conserved, thereby providing a more efficient computational platform.

Accordingly, upon receiving projects 115 (i.e., data packet related to the projects) of an organization from a project database 114, the matching engine 103 is configured to determine the enterprise policy from one or more compliance control documents 113 provided by the regulation repository 112. For each project, the matching engine 103 determines the parameters of the project. In some embodiments, the end time for the project is provided, without a start time or duration. In this regard, the start time is automatically determined by the matching engine 103 based on the tasks identified in the project and their interdependencies. These tasks are then matched to corresponding tasks that were previously successfully completed, to determine the number of hours associated with a task and their interdependencies. The start time is then adjusted accordingly. If the start time is impractical (e.g., if there is not sufficient time based on historical correlation), then the earliest possible starting date is selected and tasks that can be performed in parallel by multiple participants are assigned accordingly (i.e., in parallel) to accommodate the due date.

Upon determining the parameters of the project(s), the matching engine 103 is configured to determine the tasks that are associated with each project and their interdependencies. In one embodiment, the tasks are provided as an input to the matching engine 103 by the project database 114. For each task of a project, the matching engine 103 is configured to receive the parameters of the task 131. In various embodiments, the time (e.g., number of hours) to complete the task and/or the parameters of the task can be explicitly provided (e.g., via an administrator entry into the task database 130) or extracted by the matching engine 103 from the corpus of historic data associated with prior tasks that were successfully completed.

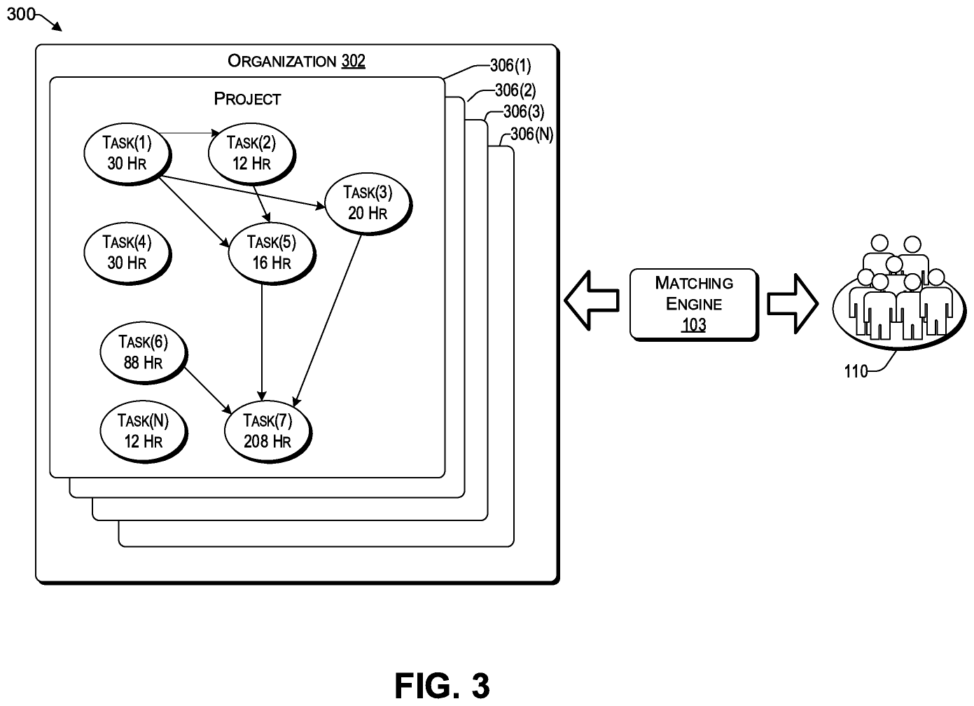

Reference now is made to FIG. 3, which is a conceptual block diagram of a participant matching system 300, consistent with an illustrative embodiment. An organization 302 may have several projects 306(1) to 306(N) that are either in progress or prospective. Each of the projects has one more tasks that may be interdependent, as illustrated by way of example in project 306(1). Each task has an associated time (i.e., number of hours) associated therewith. For example, task (1) of project 306(1) is expected to take 30 hours, whereas task (7) is expected to take 308 hours. In some embodiments, a task can be performed in parallel. In one embodiment, whether a task can be performed in parallel may be included as a time parameter. Stated differently, a task can be divided to be performed by two or more participants 110 such that it is completed at a predetermined time, which may be important for tasks that are in the critical path, such as task (1), from which tasks 2, 3, and 5 in project 306(1) directly depend. By virtue of the determining the interdependencies between the tasks of each project 306(1) to 306(N), the matching engine 103 can determine an appropriate time for a task to start and to stop. In some scenarios, there may be a start time range for a task. For example, for task (7) to commence, task (6), which takes 88 hours (if not performed in parallel), must first complete. Accordingly, the combination of task (1) plus task (2) plus task (5) (assuming that each task is not performed in parallel), is expected to take 58 hours to complete, and therefore has more tolerance to complete, whereas task (6) should be scheduled to start immediately, since it is in the critical path of the overall project completing in time.

In some scenarios, the matching engine 103 may determine that a participant in the list of participants 110 is the most appropriate candidate for two separate tasks (e.g., task (1) and task (6) in project 306(1)) which overlap in time and are deemed of [equal significance] based on enterprise policy. The matching engine can assign one task (e.g., the first task or more continuous task) to the most qualified participant, while assigning the next most qualified participant to the other task. In one embodiment, the most qualified participant is assigned to supervise the second task (i.e., assigned to the next most qualified participant) with an assumption that an amount of time to complete the first task would increase. For example, task (6), which is assigned to the most qualified participant would increase by a fraction of the amount of time the second task would take the next most qualified participant, due to time being diverted for overseeing.

Referring back to FIG. 1, in one embodiment, upon identifying the time to perform the task, including the start time, and the parameters of the task, the matching engine 103 can determine to which one or more individuals to assign a task based on multi-variable optimization. Ideally, a task should be assigned such that it is completed at the lowest cost, shortest time, and at the highest quality. However, these variables are often based on tradeoffs that cannot practically be calculated without the use of an appropriately configured computing device, such as the matching server 116 by way of the matching engine 103. The calculation can be more focused by using the identified enterprise policy in connection with the project that the subject task belongs to. As discussed above, the enterprise policy in connection with a project may be strategically important to the organization and therefore involve a high level of quality and have a higher budget. The level of quality that is associated with the project is attributed to the task as a minimum threshold level (i.e., the quality level cannot be below that minimum threshold level). Multi-variable optimization is then performed to optimize the quality, cost, and time, such that the threshold level of quality can be exceeded but not gone below. In some embodiments, one of these variables is a minimum threshold level, while the other two are optimized.

In one aspect, the goal is to find a strategy that minimizes the utility function by way of a regularization term, as provided by equation 1 below:

argmin_{X}f(X, θ_{T}, θ_{P})=L(X, θ_{T}, θ_{P})+R(λ, θ_{T}, θ_{P}) (Eq. 1)

### Where:

X denotes an assignment strategy to assign Task i (1≤i≤N) to Employee j (1≤j≤M);
xᵢ denotes the Employee of assignment of Task i in strategy X:
tᵢ denotes the time needed for Task i:
cⱼ denotes the unit cost of Employee j, and cₓ_{ᵢ} denote the cost of assignment xᵢ;
qⱼ denotes the quality of Employee j, and qₓ_{ᵢ} denote the quality of assignment xᵢ;
L denotes the utility function of assignments in a project as L(X, θ_{T}, θ_{P}) in which θ_{T} denotes the parameters of Task, e.g. time needed, etc., and θₚ denotes the parameters of Employee, e.g. cost, work quality, etc., and
R denotes the regularization term as R(λ, θ_{T}, θ_{P}) in which λ is a control parameter as input to adjust the contributions from different parameters, (e.g. to prefer a strategy with lower cost, or to prefer a strategy with better work quality).

A non-limiting example of utility function is provided by equation 2 below:

$$L ( X , {θ}_{T} , {θ}_{P} ) = {\sum }_{i = 1}^{N} \frac{{t}_{i} * {c}_{{x}_{i}}}{{q}_{{x}_{i}}} \qquad ( Eq . 2 )$$

A non-limiting example of a regularization term is provided by equation 3 below:

R(λ, θ_{T}, θ_{P})=λ₁*cₓ_{ᵢ}+λ₂*qₓ_{ᵢ}+λ₃ (Eq. 3)

In some embodiments, upon determining that a task has not been completed at a predetermined time (e.g., exceeded a time threshold), the matching engine 103 can perform a new matching iteration to better assure that the enterprise policy, including the overall deadline for a project is maintained. For example, additional resources may be allocated to subsequent tasks (e.g., participants working in parallel to complete a task) to make up for the time lost from the task in the critical path that was not completed in time. In one embodiment, an alert is sent to an appropriate administrator of the organization related to the project. The alert may be sent in various ways, such as common short code (CSC) using a short message service (SMS), multimedia message service (MMS), e-mail, telephone, social media, etc. In various embodiments, the alert can be provided on a user interface of a computing device in the form of a message on the screen, an audible tone, a haptic signal, or any combination thereof.

While the regulation repository 112, prject database 114, profile database 118, task database 130, and the matching server 116 are illustrated by way of example to be on different platforms, it will be understood that in various embodiments, these platforms may be combined in various combinations. In other embodiments, one or more of these computing platforms may be implemented by virtual computing devices in the form of virtual machines or software containers that are hosted in the cloud, thereby providing an elastic architecture for processing and storage.

### Example Processes

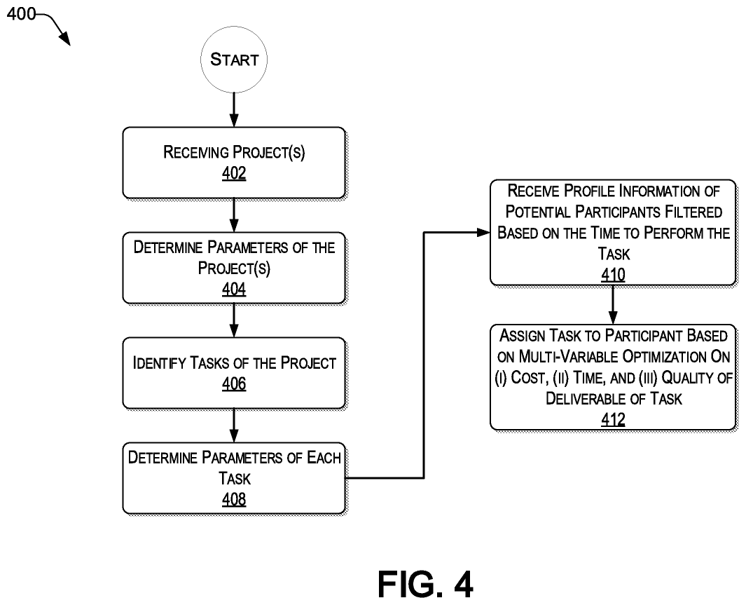

With the foregoing overview of the example architecture 100 and conceptual block diagram of a system 300, it may be helpful now to consider a high-level discussion of an example process. To that end, FIG. 4 presents an illustrative process related to matching a task in a multi task and multi project environment to an appropriate participant. Process 400 is illustrated as a collection of blocks in a logical flowchart, which represent sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process. For discussion purposes, the process 400 is described with reference to the architecture 100 of FIG. 1.

At block 402, the matching engine 103 receives a data packet 115 including one or more projects of an organization from a project database 114 over a network 106. These one or more projects may be prospective or active.

At block 404, the matching engine 103 determines the parameters of the project, such as the total cost, quality level, and the tasks associated therewith. In some embodiments, the interdependencies between the tasks are provided in the data packet 115, while in other embodiments, they can be determined from the data received from the task database 130. Some of the parameters of the project can be received from the regulation repository 112, which can include the enterprise policy for the project. In some embodiments, the parameters of a project are extracted by the matching engine 103 from various documents, such as compliance control documents 113, provided by the regulation repository 112, by way of natural language processing.

At block 406, the matching engine 103 determines the tasks of the project from the parameters of the project.

At block 408, the matching engine 103 determines the parameters of each task. To that end, the matching engine 103 receives a data packet 131 from a task database 130 from which it can extract various parameters of a task. For example, the parameters of a task may include, without limitation, a length of time to perform the task a threshold level of expertise to complete the task, and whether the task can be performed in parallel. In some embodiments, the parameters of a task may include the interdependencies between tasks.

At block 410, the matching engine 103 receives profile information of potential participants. This participant profile is filtered based on the time to perform the corresponding task, thereby conserving valuable computational and network resources. For example, the matching engine 103 sends a request via the network 106 to the profile database, based on date ranges for participants. Only the participants that are known to be available are then sent to the matching engine 103 via the network 106. The storage requirements of the matching server 116, as well as the computational needs for the various permutations evaluated is thereby significantly reduced.

At block 412, for each task, the matching engine 103 assigns the task to a participant of the filtered potential participants, based on a multi-variable optimization of cost, time, and quality of the deliverable of the task.

### Example Computer Platform

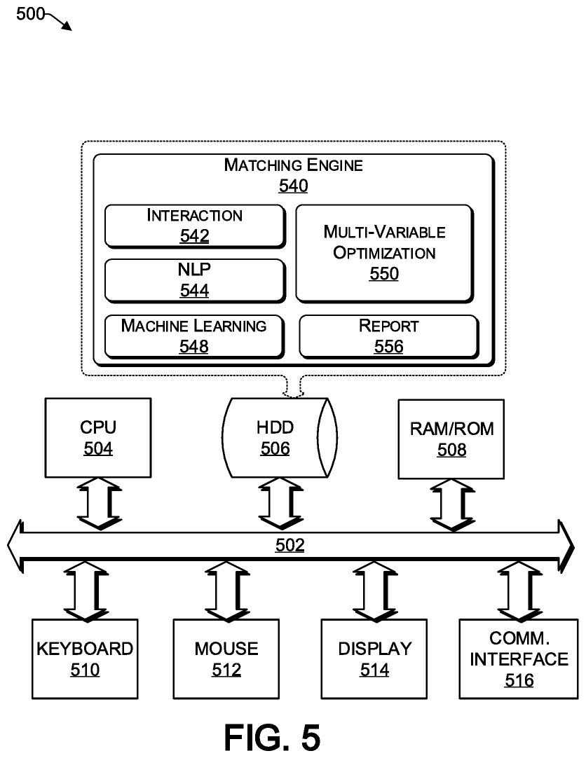

As discussed above, functions relating to automatically matching a task to a participant, can be performed with the use of one or more computing devices connected for data communication via wireless or wired communication, as shown in FIG. 1 and in accordance with the process 400 of FIG. 4. FIG. 5 provides a functional block diagram illustration of a computer hardware platform 500 that can be used to implement a particularly configured computing device that can host a matching engine 540. Accordingly, the computer hardware platform 500 is capable of communicating with a regulation repository, a project database, a task database, and a profile database and send notifications to a list of participants and/or appropriate administrator of an organization, as discussed herein. In particular, FIG. 5 illustrates a network or host computer platform 500, as may be used to implement an appropriately configured server, such as the matching server 116 of FIG. 1.

The computer platform 500 may include a central processing unit (CPU) 504, a hard disk drive (HDD) 506, random access memory (RAM) and/or read only memory (ROM) 508, a keyboard 510, a mouse 512, a display 514, and a communication interface 516, which are connected to a system bus 502.

In one embodiment, the HDD 506, has capabilities that include storing a program that can execute various processes, such as the matching engine 540, in a manner described herein. The matching engine 540 may have various modules configured to perform different functions.

For example, there may be an interaction module 542 that is operative to receive electronic data from various sources, including the regulation repository 112, project database 114, task database 130, and profile database 118.

In one embodiment, there is a natural language processing (NLP) module 544 that is operative to process the raw natural language content of one or more compliance control documents 113 to extract at least some of the parameters of the project therefrom. There may be a machine learning module 548 operative to learn from prior tasks that were successfully placed and completed, during a training phase. The machine learning module 548 may also aid in identifying the start and stop times of the tasks, the interdependencies between tasks, and whether a task can be performed in parallel.

In one embodiment, there is a multi-variable optimization module 550 that is operative to find an appropriate participant for a task to optimize a level of quality, cost, and time. There may be a report module 556 operative to send a notification to a participant to solicit their participation in a task. The report module 556 may also be used to report to an appropriate administrator of an organization the status of a task (e.g., whether it is on time, behind, or ahead of schedule). The report module 556 is operative to send the report at predetermined intervals or upon a trigger event (e.g., a participant has been identified or a task is falling behind schedule).

In one embodiment, a program, such as Apache™, can be stored for operating the system as a Web server. In one embodiment, the HDD 506 can store an executing application that includes one or more library software modules, such as those for the Java™ Runtime Environment program for realizing a JVM (Java™ virtual machine).

### Example Cloud Platform

As discussed above, functions relating to matching a participant to a task may include a cloud. It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of microservice delivery for enabling convenient, on-demand network access to a shared pool of configurable computing resources (e.g., networks, network bandwidth, servers, processing, memory, storage, applications, virtual machines, and microservices) that can be rapidly provisioned and released with minimal management effort or interaction with a provider of the microservice. This cloud model may include at least five characteristics, at least three microservice models, and at least four deployment models.

Characteristics are as follows:

On-demand self-service: a cloud consumer can unilaterally provision computing capabilities, such as server time and network storage, as needed automatically without requiring human interaction with the microservice' s provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured microservice: cloud systems automatically control and optimize resource use by leveraging a metering capability at some level of abstraction appropriate to the type of microservice (e.g., storage, processing, bandwidth, and active user accounts). Resource usage can be monitored, controlled, and reported, providing transparency for both the provider and consumer of the utilized microservice.

Service Models are as follows:

Software as a microservice (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a microservice (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a microservice (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud microservices.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is microservice oriented with a focus on statelessness, low coupling, modularity, and semantic interoperability. At the heart of cloud computing is an infrastructure that includes a network of interconnected nodes.

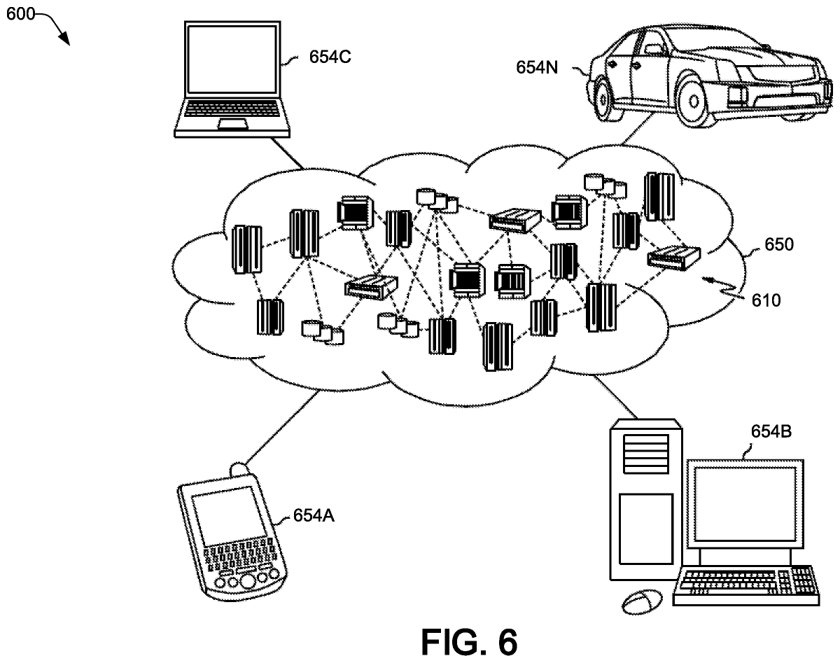

Referring now to FIG. 6, an illustrative cloud computing environment 600 is depicted. As shown, cloud computing environment 600 includes one or more cloud computing nodes 610 with which local computing devices used by cloud consumers, such as, for example, personal digital assistant (PDA) or cellular telephone 654A, desktop computer 654B, laptop computer 654C, and/or automobile computer system 654N may communicate. Nodes 610 may communicate with one another. They may be grouped (not shown) physically or virtually, in one or more networks, such as Private, Community, Public, or Hybrid clouds as described hereinabove, or a combination thereof. This allows cloud computing environment 650 to offer infrastructure, platforms and/or software as microservices for which a cloud consumer does not need to maintain resources on a local computing device. It is understood that the types of computing devices 654A-N shown in FIG. 6 are intended to be illustrative only and that computing nodes 610 and cloud computing environment 650 can communicate with any type of computerized device over any type of network and/or network addressable connection (e.g., using a web browser).

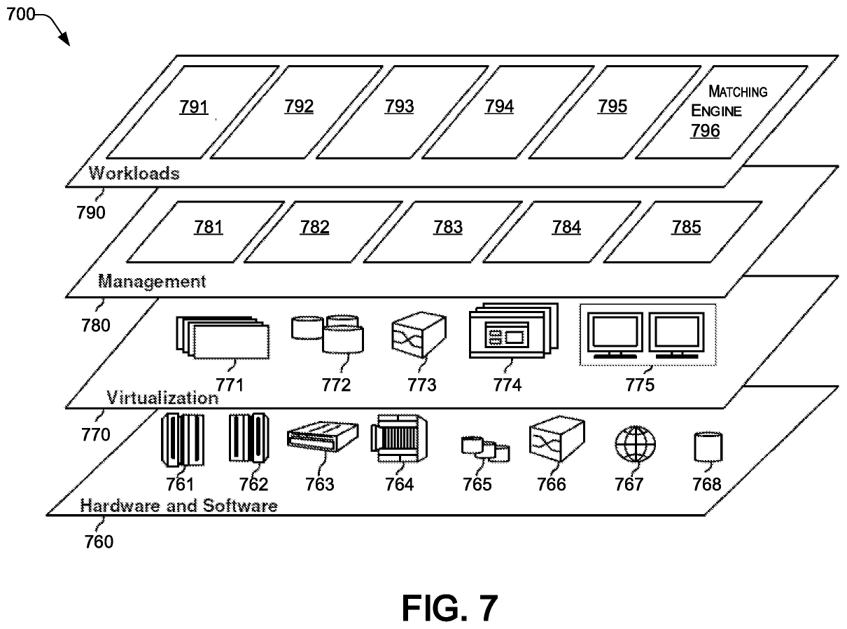

Referring now to FIG. 7, a set of functional abstraction layers provided by cloud computing environment 650 (FIG. 6) is shown. It should be understood in advance that the components, layers, and functions shown in FIG. 7 are intended to be illustrative only and embodiments of the disclosure are not limited thereto. As depicted, the following layers and corresponding functions are provided:

Hardware and software layer 760 includes hardware and software components. Examples of hardware components include: mainframes 761; RISC (Reduced Instruction Set Computer) architecture-based servers 762; servers 763; blade servers 764; storage devices 765; and networks and networking components 766. In some embodiments, software components include network application server software 767 and database software 768.

Virtualization layer 770 provides an abstraction layer from which the following examples of virtual entities may be provided: virtual servers 771; virtual storage 772; virtual networks 773, including virtual private networks; virtual applications and operating systems 774; and virtual clients 775.

In one example, management layer 780 may provide the functions described below. Resource provisioning 781 provides dynamic procurement of computing resources and other resources that are utilized to perform tasks within the cloud computing environment. Metering and Pricing 782 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 783 provides access to the cloud computing environment for consumers and system administrators. microservice level management 784 provides cloud computing resource allocation and management such that required microservice levels are met. microservice Level Agreement (SLA) planning and fulfillment 785 provide pre-arrangement for, and procurement of, cloud computing resources for which a future requirement is anticipated in accordance with an SLA.

Workloads layer 790 provides examples of functionality for which the cloud computing environment may be utilized. Examples of workloads and functions which may be provided from this layer include: mapping and navigation 791; software development and lifecycle management 792; virtual classroom education delivery 793; data analytics processing 794; transaction processing 795; and matching engine 796, as discussed herein.

### Conclusion

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computing device comprising:
a processor;
a network interface coupled to the processor to enable communication over a network;
a storage device coupled to the processor;
a matching engine code stored in the storage device, wherein an execution of the code by the processor configures the computing device to perform acts comprising:
receiving a project;
determining parameters of the project;
identifying tasks of the project from the parameters;
for each task:
determining parameters of the task, comprising a time to perform the task and a threshold level of expertise to perform the task;
receiving profile information of potential participants filtered based on the time to perform the task, to conserve the storage device and a processing power of the processor; and
assigning the task to a participant of the filtered potential participants based on multi-variable optimization on cost, time, and quality of a deliverable of the task.

2. The computing device of claim 1, wherein the parameters of the project comprise:
a total cost of the project;
a quality level of the project;
a completion time of the project; and
the tasks of the project.

3. The computing device of claim 2, wherein the parameters of the project further comprise any interdependencies between the tasks.

4. The computing device of claim 2, wherein the parameters of the project further comprise an enterprise policy for the project.

5. The computing device of claim 4, wherein the enterprise policy is extracted from one or more documents having natural language content, through natural language processing (NLP).

6. The computing device of claim 1, wherein the time to perform the task comprises a start time range and an expected duration of the task.

7. The computing device of claim 1, wherein determining the parameters of the task further comprises determining whether the task can be performed in parallel.

8. The computing device of claim 7, wherein execution of the code by the processor further configures the computing device to perform acts comprising: for each task, upon determining that the task is behind schedule and that a subsequent task can be performed in parallel, reassigning the subsequent task to one or more additional participants such that the corresponding project completes on schedule.

9. A non-transitory computer readable storage medium tangibly embodying a computer readable program code having computer readable instructions that, when executed, causes a computer device to carry out a method of matching a participant to a task, the method comprising:
receiving a project;
determining parameters of the project;
identifying the tasks of the project from the parameters;
for each task:
determining parameters of the task, comprising a time to perform the task and a threshold level of expertise to perform the task;
receiving profile information of potential participants filtered based on the time to perform the task, to conserve a memory and a processing power of the computer device; and
assigning the task to a participant of the filtered potential participants based on multi-variable optimization on cost, time, and quality of a deliverable of the task.

10. The non-transitory computer readable storage medium of claim 9, wherein the parameters of the project comprise:
a total cost of the project;
a quality level of the project;
a completion time of the project; and
the tasks of the project.

11. The non-transitory computer readable storage medium of claim 10, wherein the parameters of the project further comprise any interdependencies between the tasks.

12. The non-transitory computer readable storage medium of claim 10, wherein the parameters of the project further comprise an enterprise policy for the project.

13. The non-transitory computer readable storage medium of claim 12, wherein the enterprise policy is extracted from one or more documents having natural language content, through natural language processing (NLP).

14. The non-transitory computer readable storage medium of claim 9, wherein the time to perform the task comprises a start time range and an expected duration of the task.

15. The non-transitory computer readable storage medium of claim 9, wherein determining the parameters of the task further comprises determining whether the task can be performed in parallel.

16. The non-transitory computer readable storage medium of claim 15, wherein execution of the code by the processor further configures the computing device to perform acts comprising: for each task, upon determining that the task is behind schedule and that a subsequent task can be performed in parallel, reassigning the subsequent task to one or more additional participants such that the corresponding project completes on schedule.

17. A computing device comprising:
a processor;
a storage device coupled to the processor;
a matching engine configured to perform acts comprising:
receiving a plurality of projects;
determining parameters of each of the plurality of projects;
for each project, identifying the tasks of the project from its parameters;
for each task:
determining parameters of the task, comprising a time to perform the task and a threshold level of expertise to perform the task;
receiving profile information of potential participants filtered based on the time to perform the task, to conserve the storage device and a processing power of the processor; and
assigning the task to a participant of the filtered potential participants based on multi-variable optimization on cost, time, and quality of a deliverable of the task.

18. The computing device of claim 17, wherein, for each project, the parameters of the project comprise:
a total cost of the project;
a quality level of the project;
a completion time of the project; and
the tasks of the project.

19. The computing device of claim 18, wherein, for each project, the parameters of the project further comprise:
any interdependencies between the tasks; and
an enterprise policy for the project

20. The computing device of claim 19, wherein the enterprise policy is extracted from one or more documents having natural language content, through natural language processing (NLP).
